(19) United States
(12) Patent Application Publication
(10) Pub. No.: US 2025/0214846 A1
(43) Pub. Date: Jul. 3, 2025

(54) METHOD FOR PRODUCING CARBON FROM LIGNIN

(71) Applicant: Stora Enso OYJ, Helsinki (FI)

(72) Inventors: Vilhelm Olsson, Täby (SE); Ulrika Stockwell, Stockholm (SE)

(73) Assignee: Stora Enso OYJ, Helsinki (FI)

(21) Appl. No.: 18/853,526

(22) PCT Filed: Apr. 3, 2023
(86) PCT No.: PCT/IB2023/053332

§ 371 Date: Oct. 2, 2024

(30) Foreign Application Priority Data
Apr. 4, 2022 (SE) 2250425-2

(51) Int. Cl. C01B 32/318

(52) U.S. Cl. CPC C01B 32/318; C01P 2006/80

(57) ABSTRACT

The present invention relates to a method for producing carbon comprising the steps of: providing lignin having a total metal content of less than 200 ppm to heat treatment at one or more temperatures in the range of from 300° C. and 1500° C. to obtain carbon. The present invention also relates to carbon having a total metal content below 800 ppm; a negative electrode for a secondary battery comprising said carbon as active material; and use of said carbon as active material in a negative electrode of a secondary battery.

### FIELD OF THE INVENTION

The present invention relates to a method for producing carbon from lignin, wherein the lignin has a total metal content of less than 200 ppm. In addition, the present invention relates to carbon obtained from lignin and having a total metal content below 800 ppm, which carbon is suitable for use in energy storage applications due to the low metal content.

### BACKGROUND

Carbon enriched materials can be used for various end-uses, such as bio-chars, activated carbons and energy-storage materials. Most carbon enriched materials today are produced from fossil-based precursors.

It would be desirable to use lignin as an alternative to fossil-based carbon-containing materials. Lignin, an aromatic polymer, is a major constituent in e.g. wood, and is the most abundant carbon source on Earth second only to cellulose. In recent years, with development and commercialization of technologies to extract lignin in a highly purified, solid and particularized form from the pulp-making process, it has attracted significant attention as a possible renewable substitute to primarily aromatic chemical precursors currently sourced from the petrochemical industry.

One use of carbon enriched materials is as the negative electrode in a secondary battery, such as a lithium-ion battery. Graphite (natural or synthetic graphite) is today commonly utilized as the material of the negative electrode in most lithium-ion batteries. An alternative to graphite is amorphous carbon materials, such as hard carbons (non-graphitizable amorphous carbons) and soft carbons (graphitizable amorphous carbons), which lack long-range graphitic order. Amorphous carbons can be used as sole active electrode materials or in mixtures with graphite (and/or other active materials) and can be derived from lignin. Amorphous carbons derived from lignin are typically non-graphitizable, i.e. hard carbons.

Today, the most commercially relevant source of lignin is kraft lignin. This lignin is obtained from hardwood or softwood through the kraft process. The lignin can be separated from alkaline black liquor using for example membrane-or ultrafiltration. LignoBoost is one common separation process and is described in for example WO2006031175 A1. In this process, lignin is precipitated from alkaline black liquor through reducing the pH level, usually by adding carbon dioxide, and then filtered off. The lignin filter cake is in the next step re-slurried under acidic conditions, commonly using sulfuric acid, and washed. The precipitated washed lignin can be used as it is or further dried.

Black liquor is readily available as a by-product from the kraft process and is thus a cost-efficient lignin source. However, as black liquor contains a certain amount of metals, mostly originating from wood and from cooking chemicals used during the pulping process, lignin precipitated from the black liquor will also contain a certain amount of metals. Generally, the lignin will comprise relatively high levels of sodium and potassium as well as lower amounts of other metals such as aluminum, calcium, iron, magnesium and manganese The lignin may also comprise trace amounts of other metals.

Some metals, such as sodium and potassium, can to a large extent be removed from precipitated lignin by acidic washing steps during the separation process. Other metals, such as iron, are however harder to remove from the precipitated lignin.

There are stringent purity requirements for carbon enriched materials used in applications such as energy storage applications. It is therefore important that the purity levels of lignin used for producing carbon intended for those applications is sufficiently high. In particular, the metal content of the lignin needs to be sufficiently low. Any metals present in lignin will remain after carbonization and thus also be present in the carbon enriched material. The metals may for example interfere with the functionality of the carbon enriched material, such as the electrochemical properties and the long-term cycling performance. Specifically, transition metals such as iron and manganese may, if present in energy storage applications involving carbon enriched materials obtained from lignin, have a negative impact on the long-term stability of the energy storage device. It is believed that this is caused by precipitation of transition metals during charging and discharging, and also by decomposition of the electrolyte by reactions in turn catalyzed by transition metals.

In addition, metals present during carbonization of lignin may also catalyze processes that lead to structural modifications in the obtained carbon enriched material. It is of particular importance to maintain the carbon structure when the carbon enriched material is intended for use in applications such as energy storage devices and capacitors, where the carbon structure is crucial for achieving the proper functioning of the device.

Lignin may also be obtained through different fractionation methods such as an organosolv process or hydrolysis lignin. The organosolv process is however of less commercial interest for producing lignin compared to the kraft process.

Various attempts of removing metals from lignin have been made. Common for these methods is that they are rather complex involving many additional processing steps; and/or that they are not sufficiently efficient in their metal removal efficiency leading to insufficient purity levels and/or long washing times.

KR101451299 B1 discloses a method where lignin is repeatedly dissolved and precipitated in order to obtain a lignin with low ash content. However, many additional process steps are required.

WO2020013752 A1 discloses a method where lignin is dissolved in an acidic aqueous solvent. Through phase separation a two-phase system is obtained, where one phase is a lignin rich phase, and the other phase is poor in lignin and comprises metal cations extracted from lignin. Many additional process steps are however required.

Thus, there is a need for an improved method for producing carbon having a sufficiently low metal content such that the carbon is suitable for use in energy storage applications. In addition, the method should be cost-efficient and compatible with large-scale manufacturing.

### SUMMARY OF THE INVENTION

It is an object of the present invention to provide an improved method for producing carbon from lignin, which method eliminates or alleviates at least some of the disadvantages of the prior art methods.

It is a further object of the present invention to provide a method for producing carbon from lignin, wherein the carbon has a sufficiently low metal content that renders it suitable for use in energy-storage applications, such as the hard carbon active material in a negative electrode of a secondary battery, such as a lithium-ion battery.

It is a further object of the present invention to provide a method for producing a purified carbon from lignin, which method is compatible with large-scale manufacturing.

The above-mentioned object, as well as other objects as will be realized by the person skilled in the art in light of the present invention, are achieved by the various aspects of the present invention.

According to a first aspect, the present invention is directed to a method for producing carbon, wherein the method comprises the following steps:
i) providing lignin having a total metal content of less than 200 ppm;
ii) subjecting the lignin to heat treatment at one or more temperatures in the range of from 300° C. and 1500° C., wherein the heat treatment is carried out for a total time of from 30 minutes to 10 hours, to obtain carbon.

The inventive method according to the first aspect is based on the surprising realization that carbon suitable for use in energy storage applications can be achieved by carbonization of lignin having a total metal content of less than 200 ppm. As the metal content in the lignin is low, the metal content in carbon obtained from said lignin is also low. In particular, the content of iron and/or manganese in the obtained carbon is low.

The lignin having a total metal content of less than 200 ppm is preferably obtained by a method comprising the following steps:
a) providing lignin in solid form;
b) providing an acidic aqueous solution having a pH below 6;
c) immersing the lignin in the acidic aqueous solution for at least 15 minutes, wherein the temperature of the acidic aqueous solution during the immersion is in the range of from 40° C. to 100° C., to remove metals from lignin to the acidic aqueous solution so as to obtain purified lignin having a total metal content of less than 200 ppm;
d) separating the obtained purified lignin from the acidic aqueous solution; and
e) optionally washing the separated purified lignin
   wherein the lignin remains in solid form during all steps of the method.

It has surprisingly been found that metals can be removed from lignin by immersing the lignin in an acidic aqueous solution for at least 15 minutes at a temperature in the range of from 40° C. to 100° C. This enables a method for purifying lignin that is fast and comprises few additional method steps. The method is thus compatible with large-scale manufacturing.

According to a second aspect, the present invention is directed to carbon obtained from lignin, wherein the carbon has a total metal content of less than 400 ppm.

The carbon according to the second aspect can preferably be used in energy-storage applications, such as active material in a negative electrode of a secondary battery. The low content of metals in the carbon provides for improved electrochemical properties, such as charge/discharge capacity and long-term cycling performance.

According to a third aspect, the present invention is directed to a negative electrode for a non-aqueous secondary battery comprising the carbon obtainable by the method according to the first aspect as active material.

According to a fourth aspect, the present invention is directed to use of the carbon obtainable by the method according to the first aspect as active material in a negative electrode of a secondary battery, such as a lithium-ion battery.

### DETAILED DESCRIPTION

It is intended throughout the present description that the term “lignin” refers to any kind of lignin which may be used as the carbon source for making a carbon material. Examples of said lignin are, but are not limited to, lignin obtained from vegetable raw material such as wood, e.g. softwood lignin, hardwood lignin, and lignin from annular plants. Also, lignin can be chemically modified.

Preferably, the lignin has been purified or isolated before being used in the process according to the present invention. The lignin may be isolated from black liquor and optionally be further purified before being used in the process according to the present invention. The purification is typically such that the purity of the lignin is at least 90%, preferably at least 95%, more preferably at least 98%, based on the dry weight of the lignin material. Thus, the lignin material used according to the process of the present invention preferably contains less than 10%, preferably less than 5%, more preferably less than 2% impurities, such as cellulose, carbohydrates and inorganic compounds, based on the dry weight of the lignin material.

The lignin may be obtained through different fractionation methods such as an organosolv process or a Kraft process. Preferably, lignin used in the method of the present invention is Kraft lignin, i.e. lignin obtained through the Kraft process. Preferably, the Kraft lignin is obtained from hardwood or softwood, most preferably from softwood.

The lignin may be obtained by using the process disclosed in WO2006031175 A1 commonly referred to as the LignoBoost process. Typically, this process involves the steps of precipitation of lignin from alkaline black liquor by acidification; separation of the precipitated lignin; and re-slurrying the lignin under acidic conditions at least once. The obtained lignin may be dried and pulverized and thus provided as solid particles. The lignin obtained by this method typically has a total metal content in the range of from 500 ppm to 5000 ppm, originating mainly from the wood source and cooking chemicals added during the pulping process. The pH of the obtained lignin is typically in the range of from 3 to 4, and the sulfur content is typically around 1-3 wt %.

Step i) of the method according to the first aspect involves providing lignin having a total metal content of less than 200 ppm. The term “total metal content”, as used herein, refers to the total amount of metals present in the lignin. Typically, these metals are sodium, potassium, magnesium, calcium, aluminum, iron and manganese. Trace amounts of other metals may also be present. The metal content may be determined by inorganic elemental analysis using inductively coupled plasma optical emission spectroscopy (ICP-OES). The total metal content is determined by summarizing the amounts of all individual metals. The lignin provided in step i) of the method according to the first aspect of the present invention has a total metal content of less than 200 ppm, preferably less than 150 ppm and more preferably less than 100 ppm.

The lignin provided in step i) of the method according to the first aspect may also have an iron content of less than 15 ppm, preferably less than 10 ppm.

The lignin provided in step i) of the method according to the first aspect may also have a manganese content of less than 10 ppm, preferably less than 6 ppm.

The lignin provided in step i) of the method according to the first aspect may also have an aluminum content of less than 17 ppm, or less than 13 ppm; a calcium content of less than 16 ppm, or less than 10 ppm; a potassium content of less than 10 ppm, or less than 5 ppm; a magnesium content of less than 42 ppm, or less than 25 ppm; and a sodium content of less than 30 ppm, or less than 15 ppm.

In an alternative embodiment, the lignin provided in step i) of the method according to the first aspect may have a total metal content in the range of from 0 to 200 ppm, such as from 0.1 to 200 ppm, preferably in the range of from 0 to 150 ppm, such as from 0.1 to 150 ppm and more preferably in the range of from 0 to 100 ppm, such as from 0.1 to 100 ppm.

In an alternative embodiment, the lignin provided in step i) of the method according to the first aspect may have an iron content in the range of from 0 to 15 ppm, or from 0 to 10 ppm, or from 0.1 to 15 ppm, or from 0.1 to 10 ppm.

In an alternative embodiment, the lignin provided in step i) of the method according to the first aspect may have a manganese content in the range of from 0 to 10 ppm, or from 0 to 6 ppm, or from 0.1 to 10 ppm, or from 0.1 to 6 ppm.

In an alternative embodiment, the provided in step i) may have an aluminum content in the range of from 0 to 17 ppm, or from 0 to 13 ppm; a calcium content in the range of from 0 to 16 ppm, or from 0 to 10 ppm; a potassium content in the range of from 0 to 10 ppm, or from 0 to 5 ppm; a magnesium content in the range of from 0 to 42 ppm, or from 0 to 25 ppm; and a sodium content in the range of from 0 to 30 ppm, or from 0 to 15 ppm.

In an alternative embodiment, the lignin provided in step i) may have an aluminum content in the range of from 0.1 to 17 ppm, or from 0.1 to 13 ppm; a calcium content in the range of from 0.1 to 16 ppm, or from 0.1 to 10 ppm; a potassium content in the range of from 0.1 to 10 ppm, or from 0.1 to 5 ppm; a magnesium content in the range of from 0.1 to 42 ppm, or from 0.1 to 25 ppm; and a sodium content in the range of from 0.1 to 30 ppm, or from 0.1 to 15 ppm.

The lignin provided in step i) of the method according to the first aspect may also have a silicon content of less than 80 ppm, such as in the range of from 0 to 80 ppm, or from 0.1 to 80 ppm.

The lignin provided in step i) of the method according to the first aspect is in solid form, i.e. it is not in a dissolved state. Preferably, the lignin provided in step i) of the method according to the first aspect is in particulate form, such as in the form of a powder. The particle size distribution of the lignin particles is preferably such that at least 80 wt-% of the particles have a diameter less than 0.2 mm. In the context of the present invention, the diameter of a particle is the equivalent spherical diameter of the particle, if the particle is not spherical. The equivalent spherical diameter is the diameter of a sphere of equivalent volume.

The lignin having a total metal content of less than 200 ppm provided in step i) of the method according to the first aspect is preferably obtained by a method for purifying lignin comprising the following steps:
a) providing lignin in solid form;
b) providing an acidic aqueous solution having a pH below 6;
c) immersing the lignin in the acidic aqueous solution for at least 15 minutes, wherein the temperature of the acidic aqueous solution during the immersion is in the range of from 40° C. to 100° C., to remove metals from lignin to the acidic aqueous solution so as to obtain purified lignin having a total metal content of less than 200 ppm;
d) separating the obtained purified lignin from the acidic aqueous solution; and
e) optionally washing the separated purified lignin
   wherein the lignin remains in solid form during all steps of the method.

The lignin provided in step a) of the method for purifying lignin is in solid form, i.e. it is not in a dissolved state. The lignin may be provided in the form of a dry powder. Alternatively, the lignin may be moist or provided in a slurry or suspension. The lignin may also be provided as a crushed lignin cake obtained from a lignin separation process. The lignin is not dissolved during any of the steps in the method for purifying lignin but remains in solid form.

Alternatively, the lignin may be dissolved to a small extent, such that only small fragments of the solid lignin is dissolved, during the steps of the method according to the present invention. Thus, the lignin will remain largely in solid state. Any dissolved lignin will be removed during the separation step and discarded from the process.

The lignin provided in step a) of the method for purifying lignin may have a total metal content of at least 500 ppm, preferably at least 600 ppm and more preferably at least 700 ppm. In another embodiment, the lignin provided in step a) of the method for purifying lignin has a total metal content in the range of from 500 ppm to 5000 ppm, preferably in the range from 600 ppm to 3000 ppm, and more preferably from 700 ppm to 1500 ppm.

In an alternative embodiment, the lignin provided in step a) of the method for purifying lignin may have an aluminum content of at least 18 ppm, or at least 19 ppm; a calcium content of at least 18 ppm, or at least 19 ppm; an iron content of at least 16 ppm or at least 17 ppm; a potassium content of at least 30 ppm, or at least 50 ppm; a magnesium content of at least 45 ppm, or at least 48 ppm; a manganese content of at least 11 ppm, or at least 12 ppm; and a sodium content of at least 400 ppm, or at least 650 ppm.

In an alternative embodiment, the lignin provided in step a) of the method for purifying lignin may have an aluminum content in the range of from 18 to 25 ppm, preferably from 19 to 23 ppm; a calcium content in the range of from 18 to 40 ppm, preferably from 19 to 25 ppm; an iron content in the range of from 16 to 30 ppm, preferably from 17 to 22 ppm; a potassium content in the range of from 30 to 90 ppm, preferably from 50 to 70 ppm; a magnesium content in the range of from 45 to 55 ppm, preferably from 48 to 53 ppm; a manganese content in the range of from 11 to 30ppm, preferably from 11 to 16 ppm; and a sodium content in the range of from 400 ppm to 2000 ppm, preferably from 650 to 1000 ppm.

Step b) of the method for purifying lignin involves providing an acidic aqueous solution having a pH below 6. The term “acidic aqueous solution” as used herein, refers to any type of aqueous solution having a pH below 7. The acidic aqueous solution in step b) of the method for purifying lignin may be provided by adding at least one acid to an aqueous solution. The pH of the acidic aqueous solution provided in step b) of the method for purifying lignin has a pH below 6, preferably below 5 and more preferably below 4. In an alternative embodiment, the pH of the acidic aqueous solution may be below 7. In yet an alternative embodiment, the pH of the acidic aqueous solution may be in the range of from 1 to 6, preferably from 2 to 5, and more preferably from 1 to 4.

Lignin may be added to the aqueous solution after the acid has been added. Alternatively, lignin may be added to the aqueous solution prior to adding the acid. The aqueous solution is heated either before or after addition of the acid and lignin. In one embodiment, the acid is added to a heated aqueous solution, to which lignin is subsequently added. In another embodiment, lignin is added to an acidic aqueous solution which is subsequently heated. In yet another embodiment, acid is added to an aqueous solution comprising lignin.

In this embodiment, the aqueous solution is heated either before or after addition of acid. In a preferred embodiment, lignin is added to a heated aqueous solution, and acid is subsequently added to the aqueous solution comprising lignin.

The acidic aqueous solution provided in step b) of the method for purifying lignin comprises at least one acid such that the pH of the acidic aqueous solution is below 7, or below 6, or below 5, or below 4. In one preferred embodiment, the acidic aqueous solution comprises at least one organic acid. The organic acid may be a carboxylic acid and may be monoprotic, diprotic or triprotic. In a preferred embodiment, the organic acid has a pKa value for at least one acidic group of equal to or less than 4.75. The organic acid may be selected from at least one of acetic acid, citric acid, formic acid and oxalic acid. Preferably, the acidic aqueous solution comprises at least one organic acid selected from formic acid and oxalic acid. Using an organic acid has been found to further reduce the metal content in lignin during the immersion step. Organic acids such as formic acid and oxalic acid are cheap, easy to handle, have low toxicity and are usually less restricted to certain waste disposal regulations compared to acids containing sulfur, nitrogen and/or phosphorus.

In an alternative embodiment, the acidic aqueous solution comprises at least one inorganic acid such as sulfuric acid, hydrochloric acid or phosphoric acid.

The acidic aqueous solution may also comprise more than one acid, such as a combination of two or more organic acids or inorganic acids. The acidic aqueous solution may also comprise a combination of organic and inorganic acids. In one embodiment, the acidic aqueous solution comprises both formic acid and oxalic acid.

In one embodiment, the total amount of acid in the acidic aqueous solution may be in the range of from 0.1 to 6 wt %, preferably from 0.5 to 5 wt %, based on the total dry weight of lignin added to the acidic aqueous solution. The term “total amount of acid” as used herein, refers to the total amount of concentrated acid added to the acidic aqueous solution. Increasing the amount of acid may increase the removal of metals from lignin. From a process perspective it is however beneficial to avoid using large amounts of acids both for cost reasons and as waste handling is facilitated. Also, side reactions that may degrade lignin can be triggered by increasing the amount of acid in the acidic aqueous solution.

The acidic aqueous solution may further comprise one or more additives. The additive may be a dispersant, such as glycerol or a fatty acid. The additive may also be an oxidant such as hydrogen peroxide or EDTA. Other additives include ion exchangers such as ammonium salts such as ammonium acetate and ammonium sulfate. Additives in the acidic aqueous solution may enhance the effect of removing metals from lignin.

Step c) of the method for purifying lignin involves immersing the lignin particles in the acidic aqueous solution for at least 15 minutes, wherein the temperature of the acidic aqueous solution during the immersion is in the range of from 40° C. to 100° C., to remove metals from lignin to the acidic aqueous solution so as to obtain said purified lignin.

The term “immersion” as used herein, refers to a process of contacting lignin in solid form, such as in the form of lignin particles, with an acidic aqueous solution for a certain period of time. During the immersion step of the method for purifying lignin, the entire surface area of the lignin is in contact with the acidic aqueous solution, meaning that the lignin is fully submerged in the acidic aqueous solution.

The lignin is immersed in the acidic aqueous solution at a temperature in the range of from 40° C. to 100° C., such as from 50° C. to 90° C., or from 60° C. to 80° C. In one embodiment, the lignin is immersed in the acidic aqueous solution at a temperature in the range of from 40° C. to 110° C., such as from 80° C. to 100° C. The acidic aqueous solution may be heated using any suitable means as known by a person skilled in the art. The temperature is kept in the defined range during the entire immersion step. By heating the acidic aqueous solution, the metal removal efficiency is increased. If a too high temperature is used, the lignin may however be damaged or degraded.

The immersion time in step c) is at least 15 minutes, preferably at least 30 minutes, or even more preferably at least 1 hour. In an alternative embodiment, the immersion time is in the range of from 15 minutes to 6 hours, preferably in the range of from 30 minutes to 5 hours, or even more preferably in the range of from 1 hour to 4 hours. By increasing the immersion time, the metal removal efficiency may be increased. However, in order to enable a cost-efficient method that can easily be scaled up, it is important to have a relatively short immersion time. Still, the immersion time must be long enough for sufficient removal of metals from lignin.

Preferably, the acidic aqueous solution is stirred during the immersion. Any suitable stirring means as known by a person skilled in the art may be used.

During the immersion step, metals are removed from lignin to the acidic aqueous solution so that purified lignin is obtained. The term “purified lignin” as used herein refers to lignin that comprise essentially only lignin such as at least 99 wt % lignin based on the dry weight of the lignin material and less than 1 wt % of other components such as cellulose, carbohydrates and inorganic compounds, based on the dry weight of the lignin material. In particular, the purified lignin comprises a reduced amount of metals such that the purified lignin has a total metal content of less than 200 ppm, preferably less than 150 ppm and more preferably less than 100 ppm. As mentioned above, the lignin is not dissolved during the immersion step, which means that metals are removed from solid lignin and not from dissolved lignin. Thus, the obtained purified lignin is also in solid form, such as in the form of particles.

Step d) of the method for purifying lignin involves separating the obtained purified lignin having a total metal content of less than 200 ppm, from the acidic aqueous solution. The purified lignin is in solid form during the separation. The term “separation” as used herein, refers to a process of separating the lignin from the acidic aqueous solution.

In a preferred embodiment, the separation is performed by filtration. Alternatively, the separation may be performed by centrifuging or sedimentation or any other suitable means known by a person skilled in the art. As the purified lignin is separated from the acidic aqueous solution, the pH of the acidic aqueous solution and the lignin during the separation step will be the same as the pH during the immersion step. Thus, the pH of the aqueous acidic solution is below 6, preferably below 5, or more preferably below 4, during the step of separating the purified lignin. In one embodiment, the pH of the aqueous acidic solution may be in the range of from 1 to 7, preferably from 2 to 6, more preferably from 2 to 5, and most preferably from 2 to 4.

In one embodiment of the method for purifying lignin, the steps of immersion and separation are repeated at least once. The separated lignin is in this embodiment immersed in an acidic aqueous solution a second time, before a second separation step. The pH of the acidic aqueous solution and the temperature and time during the immersion step are selected as discussed above. In the embodiment where the immersion and separation steps are repeated, parameters such as pH, temperature and time during the immersion may be the same in all the different immersion steps or they may vary between different immersion steps. In one embodiment, the same parameters are used during two immersion steps. In one embodiment, the pH may be lower in a second immersion step than in a first immersion step. In another embodiment, the immersion time may be shorter in a second immersion step than in a first immersion step. In yet another embodiment, the temperature may be higher in a first immersion step than in a second immersion step. The total immersion time is the sum of the immersion times for the individual steps. The separation is preferably performed by filtration after each immersion step. The metal content of the lignin may be further reduced by adding additional immersion steps and by optimizing parameters such as time, temperature and pH of each step.

Step e) of the method for purifying lignin involves optionally washing the separated purified lignin. In one embodiment, the separated purified lignin is washed with an aqueous washing solution. The aqueous washing solution is preferably water. In one embodiment, the separated purified lignin is washed with water until the pH of the water used for washing becomes neutral.

The method for purifying lignin may comprise an additional step of drying the separated and optionally washed, purified lignin. The obtained purified lignin having a metal content below 200 ppm is dried after the separation step or after the optional washing step. The drying of the purified lignin is carried out by methods and equipment known in the art. The temperature during the drying is preferably in the range of from 60° C. to 160° C., more preferably in the range of from 100° C. to 120° C. The drying may be performed under reduced pressure or vacuum Preferably, the moisture content of the purified lignin after drying is less than 10 wt %, preferably less than 5 wt %.

Other inorganic impurities, such as silicon, may also be removed from lignin to the acidic aqueous solution during the immersion step. Thus, in one embodiment of the method according to the first aspect, silicon is also removed from lignin to the acidic aqueous solution in the immersion step; and the obtained purified lignin has a silicon content of less than 80 ppm, such as in the range of from 0 to 80 ppm, or from 0.1 to 80 ppm.

The obtained purified lignin may optionally be further treated before the heat treatment. These further treatment steps may involve further washing steps and heating steps. One optional treatment involves compacting purified lignin, in powder form, to lignin agglomerates, which may subsequently be thermally stabilized so that thermally stabilized agglomerated lignin is obtained. One method for obtaining such thermally stabilized agglomerated lignin is described in WO2021250604 A1.

Briefly, the purified, and preferably dried, lignin powder is compacted, and the compacted lignin is crushed to obtain agglomerated lignin. The compaction of the lignin is preferably carried out by roll compaction. In the compaction step, an intermediate product is generated. Here, the fine lignin powder is usually fed through a hopper and conveyed by means of a horizontal or vertical feeding screw into the compaction zone where the material is compacted into flakes by compaction rollers with a defined gap. By controlling the feeding screw speed, the pressure development in the compaction zone, flakes with uniform density can be obtained. The pressure development in the compaction zone can preferably be monitored and controlled by the rotational speed of the compaction rolls. As the powder is dragged between the rollers, it enters what is termed as the nip area where the density of the material is increased, and the powder is converted into a flake or ribbon. The rolls used have cavities. The depth of each cavity used in the roll compaction is from 0.1 mm to 10 mm, preferably from 1 mm to 8 mm, more preferably from 1 mm to 5 mm or from 1 mm to 3 mm. The specific press force exerted during the compaction may vary depending on the equipment used for compaction, but may be in the range of from 1 kN/cm to 100 kN/cm. Equipment suitable for carrying out the compaction is known in the art.

In the crushing step, the intermediate product from the compaction step is subjected to crushing or grinding, such as by means of rotary granulator, cage mill, beater mill, hammer mill or crusher mill and/or combinations thereof. During this step, a further intermediate product is generated.

After crushing, the crushed material is preferably subjected to a sieving step, to remove fine material. In addition, large material, such as agglomerates having a diameter larger than 5.0 mm, may be removed and/or recirculated back to the crushing step.

The agglomerated lignin may also be thermally stabilized by a heat treatment. The heating to produce thermally stabilized agglomerated lignin is carried out at such that the agglomerated lignin is heated to a temperature in the range of from 140 to 250° C., preferably from 180 to 230° C. The heating is carried out for at least 1.5 hours, i.e. the residence time of the agglomerated lignin inside the equipment used for the heating is at least 1.5 hours.

Preferably, the heating is carried for less than 12 hours. The heating may be carried out at the same temperature throughout the entire heating stage or may be carried out at varying temperature, such as a stepwise increase of the temperature or using a temperature gradient. More preferably, the heating is carried out such that the agglomerated lignin is first heated to a temperature of from 140 to 175° C. for a period of at least one hour and subsequently heated to a temperature of from 175 to 250° C. for at least one hour.

By performing treatments such as agglomeration and thermal stabilization, the lignin will be less prone to melting/swelling and changes in dimension during the subsequent heat treatment.

In step ii) of the method according to the first aspect of the present invention, the lignin having a metal content of less than 200 ppm is subjected to heat treatment at one or more temperatures in the range of from 300° C. to 1500° C., wherein the heat treatment is carried out for a total time of from 30 minutes to 10 hours, to obtain a carbon material.

The term “heat treatment” as used herein, refers to a process of heating the lignin at one or more temperatures and for a sufficient time so that the lignin is converted to carbon. Depending on the temperature during the heat treatment, different types of carbon, such as charcoal or hard carbon, can be obtained from lignin.

Preferably, the heat treatment comprises a preliminary heating step, preferably followed by a final heating step. The preliminary heating step is preferably carried out at a temperature of between 300 and 800° C., such as between 500 and 700° C. under inert atmosphere, preferably nitrogen atmosphere. The duration of the preliminary heating step is at least 30 minutes and preferably less than 10 hours. The preliminary and final heating steps may be carried out as discrete steps or as one single step in direct sequence. The surface area of the product obtained after the preliminary heating step is typically in the range of from 300 to 700 m²/g, measured as BET using nitrogen gas.

The final heating step is preferably carried out at a temperature between 800° C. and 1500° C., under inert atmosphere, preferably nitrogen atmosphere. The duration of the final heating step is at least 30 minutes and preferably less than 10 hours. After the final heating step carried out at 1000° C. or higher, the surface area of the product obtained is typically 50 m²/g or less.

Preferably, the heat treatment is carried out stepwise. Preferably, the preliminary heating starts at about 300° C. and is subsequently increased to about 500° C. The final heating step is preferably carried out between 900° C. and 1300° C., such as at about 1000° C.

Any metals present in the lignin will remain also after conversion to carbon and thus be present in the obtained carbon. The weight of lignin may be reduced by conversion to carbon whereas the weight of any metals present is not affected by the heat treatment to any significant extent. Thus, the total metal content measured by weight in the carbon may be increased compared to the total metal content in the lignin from which the carbon was obtained. In one embodiment, the obtained carbon has a total metal content of less than 800 ppm, such as less than 600 ppm, or less than 400 ppm, or less than 200 ppm.

Metals in the carbon may originate not only from the lignin starting material, but may also be due to contaminations during the process of converting lignin to carbon.

In one embodiment, the obtained carbon has a total metal content in the range of from 0 to 800 ppm, such as from 0.1 to 800 ppm, or in the range of from 0 to 600 ppm, such as from 0.1 to 600 ppm, or in the range of from 0 to 400 ppm, such as from 0.1 to 400 ppm, or in the range of from 0 to 200 ppm, such as from 0.1 to 200 ppm.

In one embodiment, the obtained carbon has an iron content of less than 60 ppm, such as less than 40 ppm or less than 25 ppm. In one embodiment, the obtained carbon has an iron content in the range of from 0 to 60 ppm, such as from 0 to 40 ppm or from 0 to 25 ppm. In one embodiment, the obtained carbon has an iron content in the range of from 0.1 to 60 ppm, such as from 0.1 to 40 ppm or from 0.1 to 25 ppm. Carbon with such low content of iron is advantageous to use as active material in a negative electrode of a secondary battery as a high content of iron will have a negative impact on the electrochemical properties, such as the long-term cycling performance.

In one embodiment, the obtained carbon has a manganese content of less than 40 ppm, such as less than 30 ppm or less than 20 ppm. In one embodiment, the obtained carbon has a manganese content in the range of from 0 to 40 ppm, such as from 0 to 30 ppm or from 0 to 20 ppm. In one embodiment, the obtained carbon has a manganese content in the range of from 0.1 to 40 ppm, such as from 0.1 to 30 ppm or from 0.1 to 20 ppm. Carbon with such low content of manganese is advantageous to use as active material in a negative electrode of a secondary battery as a high content of manganese will have a negative impact on the electrochemical properties, such as the long-term cycling performance.

In one embodiment, the obtained carbon has an aluminum content of less than 70 ppm, such as less than 50 ppm or less than 30 ppm; a calcium content of less than 60 ppm, such as less than 50 ppm or less than 30 ppm;

a potassium content of less than 40 ppm, such as less than 30 ppm or less than 20 ppm; a magnesium content of less than 170 ppm, such as less than 130 ppm or less than 90 ppm; and a sodium content of less than 120 ppm, such as less than 90 ppm or less than 60 ppm.

In one embodiment, the obtained carbon has an aluminum content in the range of from 0 to 70 ppm, such as from 0 to 50 ppm or from 0 to 30 ppm; a calcium content in the range of from 0 to 60 ppm, such as from 0 to 50 ppm or from 0 to 30 ppm; a potassium content in the range of from 0 to 40 ppm, such as from 0 to 30 ppm or from 0 to 20 ppm; a magnesium content in the range of from 0 to 170 ppm, such as from 0 to 130 ppm or from 0 to 90 ppm; and a sodium content in the range of from 0 to 120 ppm, such as from 0 to 90 ppm or from 0 to 60 ppm.

In one embodiment, the obtained carbon may have an aluminum content in the range of from 0.1 to 70 ppm, such as from 0.1 to 50 ppm or from 0.1 to 30 ppm; a calcium content in the range of from 0.1 to 60 ppm, such as from 0.1 to 50 ppm or from 0.1 to 30 ppm; a potassium content in the range of from 0.1 to 40 ppm, such as from 0.1 to 30 ppm or from 0.1 to 20 ppm; a magnesium content in the range of from 0.1 to 170 ppm, such as from 0.1 to 130 ppm or from 0.1 to 90 ppm; and a sodium content in the range of from 0.1 to 120 ppm, such as from 0.1 to 90 ppm or from 0.1 to 60 ppm.

The obtained carbon may have a silicon content of less than 320 ppm, such as less than 240 ppm, or less than 160 ppm.

The obtained carbon material may be subjected to other treatments such as pulverization, classification, coating and further heat treatments.

According to a second aspect, the present invention is directed to carbon having a total metal content of less than 800 ppm, such as less than 600 ppm, or less than 400 ppm, or less than 200 ppm. This carbon is obtained by the method according to the first aspect. Due to the low metal content of the carbon, it is suitable for use in energy-storage applications, such as the active material in the negative electrode of a secondary battery. The carbon according to the second aspect may be further defined as set out above with reference to the first aspect.

According to a third aspect, the present invention is directed to a negative electrode for a non-aqueous secondary battery comprising the carbon obtainable by the method according to the first aspect as active material. The carbon according to the third aspect may be further defined as set out above with reference to the first aspect.

According to a fourth aspect, the present invention is directed to use of carbon obtainable by the method according to the first aspect as active material in a negative electrode of a secondary battery, such as a lithium-ion battery. The carbon according to the fourth aspect may be further defined as set out above with reference to the first aspect.

The carbon obtained by the method according to the first aspect is preferably used as an active material in a negative electrode of a non-aqueous secondary battery, such as a lithium-ion battery. Prior to use in a negative electrode, the carbon is pulverized to an average particle size of 3-20 μm. When used for producing such a negative electrode, any suitable method to form such a negative electrode may be utilized. In the formation of the negative electrode, the carbon may be processed together with further components. Such further components may include, for example, one or more binders to form the carbon into an electrode, conductive materials, such as carbon black, carbon nanotubes or metal powders, and/or further Li storage materials, such as graphite or lithium. For example, the binders may be selected from, but are not limited to, poly(vinylidene fluoride), poly(tetrafluoroethylene), carboxymethylcellulose, natural butadiene rubber, synthetic butadiene rubber, polyacrylate, poly(acrylic acid), alginate, etc., or from combinations thereof. Optionally, a solvent such as e.g. 1-methyl-2-pyrrolidone, 1-ethyl-2-pyrrolidone, water, or acetone is utilized during the processing.

### EXAMPLES

The content of inorganics, such as aluminium, calcium, iron, potassium, magnesium, manganese, sodium and silicon, in the carbonized samples was evaluated with ICP-OES (Inductively Coupled Plasma-Optical Emission Spectrometry). The carbon samples were oxidized with hydrogen peroxide and subsequently wet digested in a microwave oven with nitric acid. The contents of inorganics were quantified by ICP-OES. The total metal content was calculated by summarizing the contents of individual metals.

### Example 1

Kraft lignin powder from the LignoBoost process was added to heated water (60° C.). Thereafter (5 wt % based on the dry weight of lignin added to the water) of oxalic acid was added and the mixture was stirred at maintained temperature of 60° C. for a time period of 4 hours. Subsequently the mixture was filtered, and the lignin was collected. The washing process above was repeated one more time, whereafter the lignin was collected and dried at 60° C. down to a moisture content below 5 wt %.

The washed lignin powder was agglomerated by means of roller compaction into particles with a size distribution of 0.5-1.5 mm. The agglomerated lignin was heated slowly up to 230° C. over a period of 2 h inside a rotary kiln under air to obtain thermally stabilized agglomerated lignin. The thermally stabilized agglomerated lignin was subsequently heated up to 500° C. over a period of 2 h under inert atmosphere inside a rotary kiln to carbonize the lignin and obtain a carbon material.

The content of inorganics was measured for the lignin starting material (sample 0), after washing in acid (sample 1), and after carbonization (sample 2), and the results from ICP-analysis are summarized in table 1. The content of inorganics is decreased by the acid washing procedure. The content of inorganics is increased when comparing sample 1 and 2, due to a weight loss when lignin is converted to carbon.

TABLE 1
Content of inorganics. “Metal” refers to total metal content.

| Sample | Metal | Al | Ca | Fe | K | Mg | Mn | Na | Si |
|---|---|---|---|---|---|---|---|---|---|
| (number) | (ppm) | (ppm) | (ppm) | (ppm) | (ppm) | (ppm) | (ppm) | (ppm) | (ppm) |
| 0 | 3209 | 22 | 21 | 24 | 190 | 74 | 16 | 2862 | 69 |
| 1 | 126 | 12 | 20 | 11 | 4 | 41 | 8 | 30 | 31 |
| 2 | 290 | 40 | 40 | 30 | <10 | 60 | <10 | 100 | 70 |

In view of the above detailed description of the present invention, other modifications and variations will become apparent to those skilled in the art. However, it should be apparent that such other modifications and variations may be effected without departing from the spirit and scope of the invention.

1. A method for producing carbon, wherein the method comprises the following steps:
i) providing lignin having a total metal content of less than 200 ppm; and,
ii) subjecting the lignin to a heat treatment at one or more temperatures in a range of from 300° C. and 1500° C., wherein the heat treatment is carried out for a total time of from 30 minutes to 10 hours, to obtain carbon.

2. The method according to claim 1, wherein the lignin provided in step i) has an iron content of less than 15 ppm.

3. The method according to claim 1, wherein the lignin provided in step i) has a manganese content of less than 10 ppm.

4. The method according to claim 1, wherein the lignin provided in step i) has an aluminum content of less than 17 ppm; a calcium content of less than 16 ppm; a potassium content of less than 10 ppm; a magnesium content of less than 42 ppm; and a sodium content of less than 30 ppm.

5. The method according to claim 1, wherein the lignin provided in step i) is kraft lignin.

6. The method according to claim 1, wherein the lignin is provided as particles, and wherein a particle size distribution of the particles is such that at least 80 wt-% of the particles have a diameter less than 0.2 mm.

7. The method according to claim 1, wherein the lignin provided in step i) is produced by:
a) providing a solid lignin;
b) providing an acidic aqueous solution having a pH below 6;
c) immersing the solid lignin in the acidic aqueous solution for at least 15 minutes, wherein a temperature of the acidic aqueous solution during the immersion is in a range of from 40° C. to 100° C., to remove metals from the solid lignin to the acidic aqueous solution so as to obtain a purified lignin having a total metal content of less than 200 ppm; and,
d) separating the purified lignin from the acidic aqueous solution to provide a separated purified lignin; and
e) optionally, washing the separated purified lignin, wherein the solid lignin remains in solid form during steps a) to e).

8. The method according to claim 7, wherein a total amount of acid in the acidic aqueous solution is in a range of from 0.1 to 6 wt % based on the a dry weight of lignin immersed in the acidic aqueous solution.

9. The method according to claim 7, wherein the acidic aqueous solution comprises at least one organic acid.

10. The method according to claim 9, wherein the at least one organic acid is selected from a group consisting of: formic acid and oxalic acid.

11. The method according to claim 7, wherein the separating in step d) is performed using filtration.

12. The method according to claim 7, wherein steps c) and d), and optionally e), are each repeated at least one time.

13. The method according to claim 7, wherein the separated purified lignin is subjected to washing with an aqueous solution.

14. The method according to claim 7, further comprising: drying the separated purified lignin.

15. The method according to claim 1, wherein step ii) comprises a preliminary heating step, followed by a final heating step.

16. The method according to claim 15, wherein the preliminary heating of step ii) is carried out at a temperature of between 400° C. and 800° C. for at least 30 minutes.

17. (canceled)

18. The method according to claim 15, wherein the final heating step of step ii) is carried out at a temperature between 800° C. and 1500° C. for at least 30 minutes.

19. (canceled)

20. The method according to claim 1, wherein the obtained carbon has a total metal content of less than 800 ppm.

21. The method according to claim 1, wherein the carbon has an iron content of less than 60 ppm.

22. The method according to claim 1, wherein the carbon has a manganese content of less than 40 ppm.

23. The method according to claim 1, wherein the carbon has an aluminium content of less than 70 ppm; a calcium content of less than 60 ppm; a potassium content of less than 40 ppm; a magnesium content of less than 170 ppm; and a sodium content of less than 120 ppm.

24. (canceled)

25. (canceled)

26. (canceled)

27. (canceled)

28. (canceled)

29. (canceled)
